(19) United States
(12) Patent Application Publication
(10) Pub. No.: US 2019/0164095 A1
(43) Pub. Date: May 30, 2019

(54) NATURAL LANGUAGE PROCESSING OF FEEDS INTO FUNCTIONAL SOFTWARE INPUT

(71) Applicant: International Business Machines Corporation, Armonk, NY (US)

(72) Inventors: Kelly A. Argyros, Fairfax, VA (US); Michael A. Dawson, Tokyo (JP); Daniel J. Ferranti, Washington, DC (US); Andrew R. Freed, Cary, NC (US); Andrew S.H. Ting, Washington, DC (US)

(21) Appl. No.: 15/823,337

(22) Filed: Nov. 27, 2017

(51) Int. Cl. G06Q 10/06; G06F 17/27

(52) U.S. Cl. CPC G06Q 10/0635; G06F 17/2705; G06Q 10/0633

(57) ABSTRACT

A method, in a data processing system comprising a processor and a memory, for processing natural language feeds to software, the method comprising receiving, by the data processing system, a natural language feed including data that is representative of parameters and quantitative data from government or regulatory body data sources, parsing, by the data processing system, the natural language feed with natural language processing for features that correspond to a production system, converting, by the data processing system, the parsed natural language feed into software functions, and calibrating, by the data processing system, the production system by updating a data library using the software functions and integrating information from the data library with the production system.

### BACKGROUND

The present invention generally relates to data processing, and in particular, using natural language processing to convert natural language feeds into software input.

Natural language processing (“NLP”) is a field of computer science, artificial intelligence, and linguistics concerned with the interactions between computers and human (natural) languages. Many challenges in NLP involve natural language understanding, e.g., enabling computers to derive meaning from human or natural language input. Understanding human language includes understanding not only the words, but also the concepts and how they are organized.

### SUMMARY

A method, computing system, and computer program products are disclosed for processing natural language feeds to software. According to one embodiment, said method comprises receiving, by said data processing system, a natural language feed including data that is representative of parameters and quantitative data from government or regulatory body data sources. Said natural language feed is parsed by said data processing system with natural language processing for features that correspond to a production system. Said parsed natural language feed is converted by said data processing system into software functions. Said method further comprises calibrating, by said data processing system, said production system by updating a data library using said software functions and integrating information from said data library with said production system.

Said parameters may include data selected from the group consisting of rules, laws, regulations, contractual commitments, organizational and industry standards, codes or practice, ethical codes of conduct, good governance guidelines, and agreements with community groups or non-governmental organizations. Risk weights and ratings may also be assigned by said processing system to said parameters and quantitative data. According to one embodiment, calibrating said production system further comprises calculating, by said data processing system, an aggregate risk score for an entity based on said risk weights and ratings. Natural language feed may include data selected from the group consisting of files, data records, tables, and documents. Converting said parsed natural language feed into software functions may further comprise generating, by said data processing system, instructions for determining a change in risk weight values in said production system. In another embodiment, calibrating said production system further comprises identifying, by said data processing system, a change in at least one risk weight value associated with one or more risk components associated with an entity's operations based on said software functions.

According to one embodiment, said computing system comprises a computer processor and a computer memory operatively coupled to said computer processor. Said computer memory has disposed within it computer program instructions that, when executed by said processor, cause said computing system to receive a natural language feed including data that is representative of parameters and quantitative data from government or regulatory body data sources. Said processor parses said natural language feed with natural language processing for features that correspond to a production system. Said parsed natural language feed is converted by said processor into software functions. Said processor further calibrates said production system by updating a data library using said software functions and integrating information from said data library with said production system.

Said parameters may include data selected from the group consisting of rules, laws, regulations, contractual commitments, organizational and industry standards, codes or practice, ethical codes of conduct, good governance guidelines, and agreements with community groups or non-governmental organizations. Said processor may assign risk weights and ratings to said parameters and quantitative data. In another embodiment, said processor calculates an aggregate risk score for an entity based on said risk weights and ratings. Said may natural language feed may include data selected from the group consisting of files, data records, tables, and documents. Said processor may further generate instructions for determining a change in risk weight values in said production system. In another embodiment, said processor further identifies a change in at least one risk weight value associated with one or more risk components associated with an entity's operations based on said software functions.

According to one embodiment, said computer program product comprises a computer readable storage medium having stored thereon program instructions executable by a processing device to cause said processing device to receive a natural language feed including data that is representative of parameters and quantitative data from government or regulatory body data sources. Said computer program product also comprises program instructions executable by a processing device to cause said processing device to parse said natural language feed with natural language processing for features that correspond to a production system. Said computer program product may also comprises program instructions executable by a processing device to cause said processing device to convert said parsed natural language feed into software functions. Said computer program product further comprises program instructions executable by said processing device to cause said processing device to calibrate said production system by updating a data library using said software functions and integrating information from said data library with said production system.

Said parameters may include data selected from the group consisting of rules, laws, regulations, contractual commitments, organizational and industry standards, codes or practice, ethical codes of conduct, good governance guidelines, and agreements with community groups or non-governmental organizations. Said computer program product may further comprise program instructions executable by the processing device to cause the processing device to assign risk weights and ratings to said parameters and quantitative data. Said program instructions executable by the processing device to cause the processing device to calibrate said production system may further comprise program instructions executable by the processing device to cause the processing device to calculate an aggregate risk score for an entity based on said risk weights and ratings. In another embodiment, said program instructions executable by the processing device to cause the processing device to convert said parsed natural language feed into software functions further comprise program instructions executable by the processing device to cause the processing device to generate instructions for determining a change in risk weight values in said production system. In yet another embodiment, said program instructions executable by the processing device to cause the processing device to calibrate said production system further comprises identifying a change in at least one risk weight value associated with one or more risk components associated with an entity's operations based on said software functions.

### BRIEF DESCRIPTION OF THE DRAWINGS

FIG. 1 illustrates a computing system according to an embodiment of the present invention.

FIG. 2 illustrates another computing system according to an embodiment of the present invention.

FIG. 3 illustrates a flowchart of a method for processing natural language feeds to software according to an embodiment of the present invention.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses exemplary methods, computing systems, and computer program products for importing data feeds and updating risk assessment of an entity or product resulting based on new parameters from the data feeds. In one embodiment, a system may receive a natural language description of a new (or updated) parameter or quantitative data and determine risk weight values or changes to risk weight values that may be used to adjust a production system that may perform risk assessments. Features can be extracted from the data based on natural language processing (NLP) algorithms. The system may identify characteristics such as parameters that need to be in compliance based on the analyzed data. The assessment system can also generate a risk assessment of a product based on the identified parameters and determine an aggregate assessment of an entity based on the product risk assessment.

Exemplary methods, computing systems, and computer program products for evaluating new parameters and/or quantitative data that may impact existing operations, such as a change in aggregate risk for an entity, in accordance with the present invention, are described with reference to the accompanying drawings. The evaluation may include processing natural language data related to a plurality of risk ratings for the entity and identifying a change in at least one risk weight value. Risk ratings may include measurements of the entity's operations (e.g., physical and virtual assets, investments, holdings, obligations, provided services, functions, contracts, third-party services, technology, and processes) that are associated with one or more risk components. Data related to the entity's operations for evaluating risk may be collected or extracted from any hardware that produces data relevant the entity's operations, such as, computers, servers, mobile computing devices, and databases, etc.

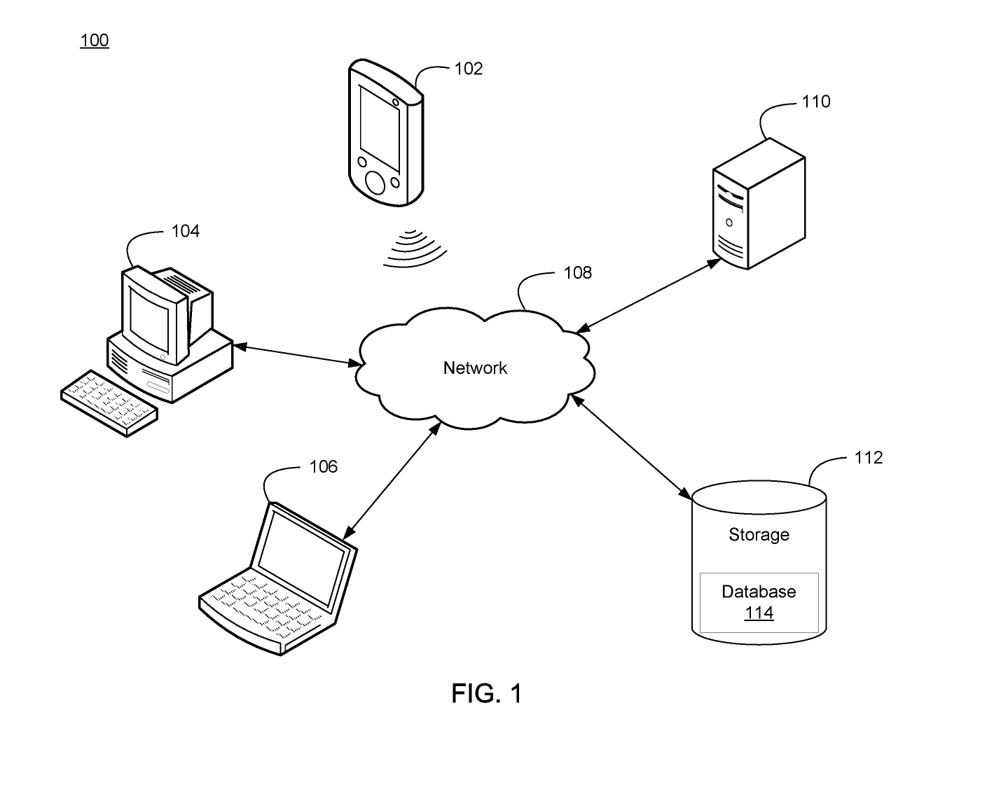

Referring now to FIG. 1, illustrative computing environment 100 is depicted. As shown, computing environment 100 includes one or more computing devices, such as, for example, personal digital assistant (PDA) or cellular telephone 102, desktop computer 104, and/or laptop computer 106. The system further includes automated computing machinery comprising the server 110 useful in NLP according to embodiments of the present invention. The server includes at least one computer processor or “CPU” as well as random access memory (“RAM”) which is connected through a high-speed memory bus and bus adapter to the processor and to other components of the server. Stored in RAM, or a hard drive connected to the RAM, may be a NLP module including computer program instructions that, when executed, cause the computer to perform natural language processing according to embodiments of the present invention by extracting specific information from one or more data sources. Stored in RAM also is an operating system. Operating systems useful for natural language processing according to embodiments of the present invention include UNIX™ Linux™ Microsoft Windows™ AIX™ IBM's i5/OS™ and others as will occur to those of skill in the art. Non-volatile computer memory also may be implemented for such as an optical disk drive, electrically erasable programmable read-only memory (so-called ‘EEPROM’ or ‘Flash’ memory), RAM drives, and so on, as will occur to those of skill in the art.

Any of the computing devices may communicate with server 110 and storage 112 over network 108 using wired or wireless communication technologies. Server 110 is operative to receive requests from the computing device, retrieve data from database 114 (stored in storage 112), and process the requests and the retrieved data to generate responses to the computing devices across the network 108. It is understood that the types of computing devices shown in FIG. 1 are intended to be illustrative only and that any type of computerized device can communicate with server 110 over any type of network and/or network addressable connection (e.g., using a web browser).

Network 108 may be any suitable type of network allowing transport of data communications across thereof. Network 108 may support many data communications protocols, including for example TCP (Transmission Control Protocol), IP (Internet Protocol), HTTP (Hypertext Transfer Protocol), WAP (Wireless Access Protocol), HDTP (Handheld Device Transport Protocol), and others as will occur to those of skill in the art. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices and servers may be encrypted using, for example, the Advanced Encryption Standard (AES) with a 128, 192, or 256-bit key size, or any other encryption standard known in the art.

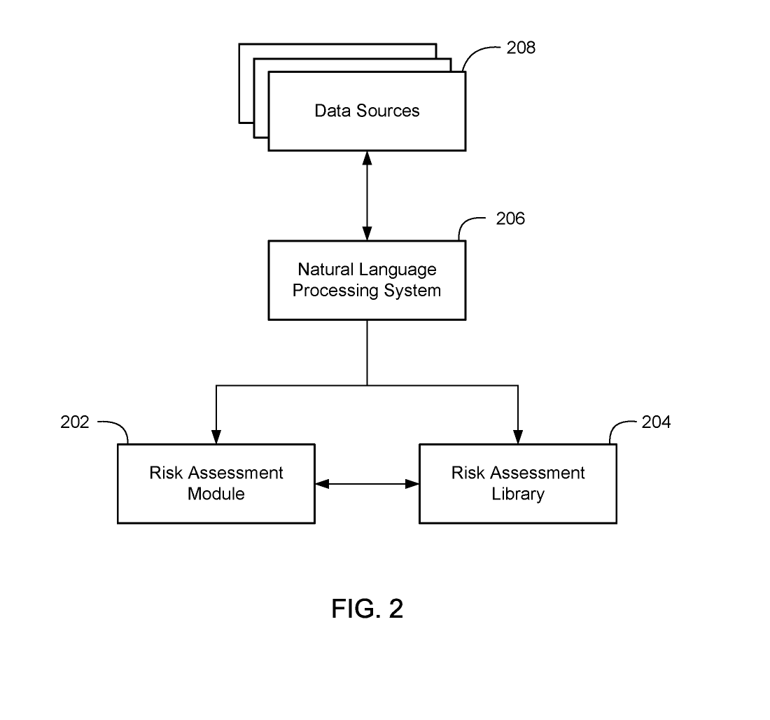

FIG. 2 presents a logical block diagram of a data processing system according to one embodiment of the present invention. The present invention is not limited to the arrangement of devices in the exemplary system illustrated in FIG. 2, but rather are for explanation. Computing systems useful according to various embodiments of the present invention may include additional servers, routers, other devices, and peer-to-peer architectures, not shown in FIG. 2, as understood by those of skill in the art.

The illustrated system includes risk assessment module 202, risk assessment library 204, natural language processing (NLP) system 206, and data sources 208. The risk assessment module 202 may be configured to allow users, via their client devices, to generate risk assessments and risk simulations of an entity and its products. A product may comprise e.g., software, policies, contracts, transactions (e.g., financial), computing services (e.g., storage, cloud computing, networking), and consulting services, that may be embodied in an electronic form and analyzed by risk assessment module 202. Risk assessment module 202 may receive and identify a set of parameters (e.g., obligations, operating environment, standards, etc.) that need to be in compliance. For example, a user may create a risk assessment for an entity or product by selecting a business unit, operational aspects, and risk categories/subcategories for the risk assessment module 202 to determine applicable parameters. Parameters may be assigned risk weights and ratings. The risk assessment module 202 may further generate risk assessment data based on the identified parameters and determine an aggregate risk assessment of the entity and/or product based on risk weights and ratings. Risk assessment data may include incidents related to the operational integrity of the entity (e.g., insider attack, malware attack, web-based attack, legal or regulatory action, physical damage or loss, website defacement, failed service management, email attack, adverse publicity, distributed denial of service (DDoS) attack, etc.).

Risk ratings may measure operational integrity associated with risk components such as, threats (such as security or financial), legal compliance, liabilities and obligations, ethical violations, social media/public relations, vulnerabilities, and incidents) for the entity. Risk weights may be created for each risk rating based on aspects of the entity's operations, such as, technology, services, compliance, assets, financial, security, etc. The risk weights may differ depending on risk component, the type of entity (e.g., certain industries, companies, or organizations), the operations performed by the entity, and other relevant factors. Risk components may also include other types of factors that may be specific for each entity and may be modified by the entity and dimensionally limited by a focus on specific aspects of risk as they relate to a specific entity. The entity may request analysis and specify a list of risk components or risk component categories associated with specific risk factors. For example, the risk assessment module 202 may receive a selection related to a specific component of a specific type of risk associated with the system. The type of risk can be a security risk on the entity. The specific components of the security risk can include negative risks to the entity associated with a loss caused by the security risk.

According to one embodiment, risk assessment module 202 may include a simulator capable of simulating the effects of incorporating a product into the entity's existing operations or offerings. A risk assessment of the product on the entity can include analyzing risk ratings of the entity to determine if at least one risk rating exceeds a threshold by incorporating one or more products. Thresholds may be set for the risk ratings and can be monitored by risk assessment module 202 for when the rating exceeds that threshold. Performing a risk assessment may further include determining vulnerabilities related to the operational integrity of the entity or product (e.g., security and regulatory awareness, security organization and resources, supplier security, location security, process control, change control, data control, mobile device control, legacy system security, security architecture, etc.). Performing risk assessments may further include risk assessment module 202 calculating an overall change in risk assessment or rating of the operations of the entity from a change in the operations based on new parameters. Calculating the overall change may include identifying a change in at least one of risk weight values associated with one or more risk components of the entity's operations and products. A change in the at least one of the risk weight value may indicate a new or unknown potential issue (e.g., threat, vulnerability, or incident) related to the entity, for example, a plurality of threats related to the operational integrity of the entity (e.g., spam pushing and pharming, malware, unauthorized access, abuse of access privilege, legal and regulatory threats, damage to hardware, loss of hardware/assets/investments, human error and social engineering, change, etc.).

Risk assessment library 204 may comprise a risk assessment database that rates or includes ratings of, for example, countries according to their risk of money laundering and terrorist financing. Each country may be assigned a risk score, a rank, and a rating of high, medium, or low, based on the cumulative weight of factors indicative of money laundering and terrorist financing. In another example, the risk assessment library may include ratings of websites, trusted sources, software reliability and vulnerability. NLP system 206 may receive or retrieve a natural language feed including parameters and/or quantitative data from data sources 208. Data sources 208 may comprise servers and/or databases of authoritative bodies such as government and regulatory body websites, websites, or databases. In an alternative embodiment, data sources may comprise news outlet servers, social media websites, and other information sources. An example of quantitative data may include a release or publication of new/latest violations of parameters including a result of the violations of parameters.

The natural language feed of parameters and/or quantitative data may be processed through the NLP system 206 and used to adjust risk rating elements in risk assessment library 204 and/or adjust risk weight valuations in risk assessment module 202. Risk assessment module 202 may use the processed natural language feed either independently or in conjunction with risk assessment library 204. In one embodiment, risk assessment module 202 is enabled to integrate with and consume data from risk assessment library 204 with the adjusted risk rating elements and calibrate calculations or assessments made by risk assessment module 202 based on the consumed data. NLP system 206 may utilize NLP for natural language understanding, e.g., deriving meaning from natural language input from data sources 208. NLP is a field of computer science, artificial intelligence, and linguistics concerned with the interactions between computers and human (natural) languages. Processing performed by NLP system 206 may include analyzing data from data sources 208 to identify unique concepts or features that are based on, for example, a reference corpus of information. That is, NLP system 206 may be trained by associating text, numbers, or characters from the reference corpus with specific labels.

NLP processing may also include decomposing the data into text fragments by grouping text segments based on logical operators, formatting codes (e.g., paragraph markers, font styles, indentions, tabs and the like), as well as the use of punctuation (e.g., periods, commas, hyphens, semicolons, colons, and the like). The text fragments may be compared to the content or an index of a plurality of data sets from the reference corpus of information. The index may indicate, for example, topics, topic types, target audiences, degrees of importance, etc., for a plurality of data sets within the corpus. In another embodiment, the text fragments may be compared with tags or metadata associated with the data sets of the corpus. For example, the data sets in the corpus of information may be categorized, organized, or indexed according to specific topics or information. Features of the text fragments may be identified based on the comparison with the index, tags, or metadata of the corpus. Scores can be assigned to the text fragments based on an evaluation of the text fragments matching one or more data sets. The scores may comprise a value that indicates a degree to which the identified features of the text fragments match one or more data sets.

In another embodiment, machine learning algorithms can be applied to improve risk weight value determination. The NLP system 206 may comprise an artificial intelligence unit trained by a model trainer (e.g., using machine learning techniques such as support vector machines, neural networks, clustering, decision tree learning, etc.) to identify text of parameters associated with certain risk components and weights. Training data may be received from various data references, including, for example, from a user through a graphical user interface presented on the display of a client device and/or from a corpus of training data. Using the artificial intelligence, risk assessment module 202 may receive data including the risk components and a weight adjustment from the NLP system 206.

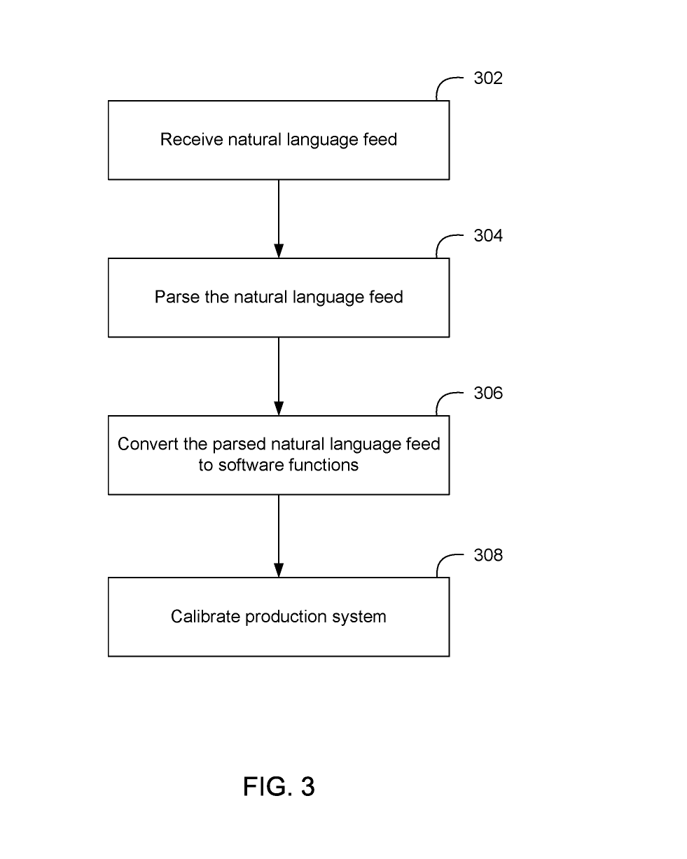

FIG. 3 presents a flowchart of a method for processing natural language feeds to software according to an embodiment of the present invention. A natural language feed is received, step 302. Receiving the natural language feed may include a data processing system obtaining data that is representative of new parameters or quantitative data. Parameters may include rules, laws, regulations, contractual commitments, organizational and industry standards, codes or practice, ethical codes of conduct, good governance guidelines, and agreements with community groups or non-governmental organizations. The natural language feed may be received as a data input or import of data such as files, data records, tables, or documents from, for example, government or regulatory body websites.

The natural language feed is parsed using natural language processing, step 304. In particular, the natural language feed may be parsed for specific features within the body of the feed that correspond to a production system (e.g., a risk assessment system). Parsing features from the natural language feed may include extracting words, numbers, characters, etc., from source code, specific files, filenames, metadata, or content from the product data. Feature parsing may also include the data processing system using NLP to analyze and derive meaning from the extracted words, numbers, characters, etc., to identify requirements corresponding to the new parameters or quantitative data, elements of the entity's operations that are applicable to the new parameters or quantitative data, and determine effect(s) and duration of the effect(s) on risk ratings for one or more risk components. Parameters may include several sections and guidance. Quantitative data may include applications of parameters including a result of the violations of parameters. The NLP may be configured to identify features and concepts, label, or otherwise classify the content of the parameters or quantitative data.

According to one embodiment, the NLP may identify specific features in the natural language feed that are based on, for example, a reference corpus of information. Certain words or strings of characters may be assigned to one or more tags identifying particular features and are stored in a dictionary. For example, the words “hedge,” “collateral,” and “leverage” may indicate particular features of a financial product that are associated with certain operational requirements, risks, and obligations. In another embodiment, the certain words or strings of characters may be used to train a classifier via machine learning (e.g., using machine learning techniques such as neural networks) to help identify features. A user may specify features that are more important than others, or present a certain degree of priority or risk. The user may also specify parameters as features that are relevant to certain industries or companies.

The parsed natural language feed is converted into software functions, step 306. In one embodiment, the parsed natural language feed may be used to generate instructions for determining risk weight values or changes to risk weight values that can be effected in a production system that may perform risk assessment. For example, the parameters or quantitative data from the feed may be assigned certain risk weights and ratings to calculate an aggregate risk score for an entity or its products. The natural language feed may include information that is parsed and identified to be materially important to assessing a change in aggregate risk or a re-weighting to risk components. For example, certain risk weight values that were previously assigned to one or more risk components of the entity's operations and products may be adjusted based on certain information parsed from the natural language feed. The adjusted risk weight values may be converted to software input or instructions to calibrate the calculation of a risk assessment.

A production system is calibrated based on the software functions, step 308. The production system may comprise a computer device including software used to provide some form of artificial intelligence having a set of behavior rules that may be used for automated planning, expert systems and action selection. According to one embodiment, calibrating the production system may include using the software functions to identify changes in at least one risk weight value associated with one or more risk components of the entity's operations and updating a data library based on the changes. Changes in the at least one of the risk weight values may indicate a new potential issue that was not accounted for in a previous risk assessment of an entity or product. Calibrating the production system may further include integrating and using information from the data library in the production system to determine a risk assessment by calculating an aggregate risk score based on the changed weight values. The risk assessment may further include a comparison of aggregate risk scores or ratings of the entity's operations or products before and after the natural language feed.

Risk assessments may include measurements or ratings associated with an entity's operations (e.g., physical and virtual assets, investments, holdings, obligations, provided services, functions, contracts, third-party services, technology, and processes) that are associated with one or more risk components. Each risk component may correlate to a given aspect of the entity's operations, e.g., threat risk component, legal risk component, liability and obligation risk component, vulnerability risk component, etc. Risk components and weights may be defined in a predetermined catalogue that may be used by any entity. According to one embodiment, certain types of risks and risk component categories to be monitored can be individually selected or customized for each entity.

Risk scores can reflect the health of the entity's operations (e.g., on a scale from ‘1’ to ‘10’ where a score of ‘1’ reflects a poor rating while a score of ‘10’ reflects an excellent rating). An aggregate risk score may be calculated for each risk component via an aggregation of values assigned to a plurality of risk components. For example, the plurality of risk components may be comprised of sets of descriptions. Each set of description may comprise descriptions that cumulatively characterize a risk component of an entity's operation. That is, each description of the set of descriptions can provide a characterization of a portion of a range, scale, and/or continuum of possible classifications and/or quantifications of a risk component. For example, if a threat assessment of a product returns four critical risk characterizations, five high risk characterizations, one medium risk characterizations, and one low risk characterization, then a risk score can be based on a weighted aggregation of the four critical risk characterizations, five high risk characterizations, one medium risk characterizations, and one low risk characterization. In one embodiment, the higher risk characterizations (e.g., on a scale comprising critical risk to high risk to medium risk, to low risk, wherein critical is the highest risk and low is the lowest risk) can be weighted more heavily to have a greater influence on an aggregate risk score. The aggregate risk scores (as well as individual risk rating values) may be provided in a summary for user review.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1 through 3 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for processing natural language feeds to software, the method comprising
receiving, by the data processing system, a natural language feed including data that is representative of parameters and quantitative data from government or regulatory body data sources;
parsing, by the data processing system, the natural language feed with natural language processing for features that correspond to a production system;
converting, by the data processing system, the parsed natural language feed into software functions; and
calibrating, by the data processing system, the production system by updating a data library using the software functions and integrating information from the data library with the production system.

2. The method of claim 1 wherein the parameters include data selected from the group consisting of: rules, laws, regulations, contractual commitments, organizational and industry standards, codes or practice, ethical codes of conduct, good governance guidelines, and agreements with community groups or non-governmental organizations.

3. The method of claim 1 further comprising assigning, by the data processing system, risk weights and ratings to the parameters and quantitative data.

4. The method of claim 3 wherein calibrating the production system further comprises calculating, by the data processing system, an aggregate risk score for an entity based on the risk weights and ratings.

5. The method of claim 1 wherein the natural language feed includes data selected from the group consisting of: files, data records, tables, and documents.

6. The method of claim 1 wherein converting the parsed natural language feed into software functions further comprises generating, by the data processing system, instructions for determining a change in risk weight values in the production system.

7. The method of claim 1 wherein calibrating the production system further comprises identifying, by the data processing system, a change in at least one risk weight value associated with one or more risk components associated with an entity's operations based on the software functions.

8. A computing system for processing natural language feeds to software, the computing system comprising a computer processor and a computer memory operatively coupled to the computer processor, the computer memory having disposed within it computer program instructions that, when executed by the processor, cause the computing system to carry out the steps of:
receiving a natural language feed including data that is representative of parameters and quantitative data from government or regulatory body data sources;
parsing the natural language feed with natural language processing for features that correspond to a production system;
converting the parsed natural language feed into software functions; and
calibrating the production system by updating a data library using the software functions and integrating information from the data library with the production system.

9. The computing system of claim 8 wherein the parameters include data selected from the group consisting of: rules, laws, regulations, contractual commitments, organizational and industry standards, codes or practice, ethical codes of conduct, good governance guidelines, and agreements with community groups or non-governmental organizations.

10. The computing system of claim 8 further comprising the processor assigning risk weights and ratings to the parameters and quantitative data.

11. The computing system of claim 10 further comprising the processor calculating an aggregate risk score for an entity based on the risk weights and ratings.

12. The computing system of claim 8 wherein the natural language feed includes data selected from the group consisting of: files, data records, tables, and documents.

13. The computing system of claim 8 further comprises the processor generating instructions for determining a change in risk weight values in the production system.

14. The computing system of claim 8 further comprising the processor identifying a change in at least one risk weight value associated with one or more risk components associated with an entity's operations based on the software functions.

15. A computer program product for processing natural language feeds to software, the computer program product comprising:
a computer readable storage medium having stored thereon:
program instructions executable by a processing device to cause the processing device to receive a natural language feed including data that is representative of parameters and quantitative data from government or regulatory body data sources;
program instructions executable by the processing device to cause the processing device to parse the natural language feed with natural language processing for features that correspond to a production system;
program instructions executable by the processing device to cause the processing device to convert the parsed natural language feed into software functions; and
program instructions executable by the processing device to cause the processing device to calibrate the production system by updating a data library using the software functions and integrating information from the data library with the production system.

16. The computer program product of claim 15 wherein the parameters include data selected from the group consisting of: rules, laws, regulations, contractual commitments, organizational and industry standards, codes or practice, ethical codes of conduct, good governance guidelines, and agreements with community groups or non-governmental organizations.

17. The computer program product of claim 15 further comprising program instructions executable by the processing device to cause the processing device to assign risk weights and ratings to the parameters and quantitative data.

18. The computer program product of claim 17 wherein the program instructions executable by the processing device to cause the processing device to calibrate the production system further comprises program instructions executable by the processing device to cause the processing device to calculate an aggregate risk score for an entity based on the risk weights and ratings.

19. The computer program product of claim 15 wherein the program instructions executable by the processing device to cause the processing device to convert the parsed natural language feed into software functions further comprises program instructions executable by the processing device to cause the processing device to generate instructions for determining a change in risk weight values in the production system.

20. The computer program product of claim 15 wherein the program instructions executable by the processing device to cause the processing device to calibrate the production system further comprises program instructions executable by the processing device to cause the processing device to identify a change in at least one risk weight value associated with one or more risk components associated with an entity's operations based on the software functions.
